(19) United States
(12) Patent Application Publication
(10) Pub. No.: US 2020/0019412 A1
(43) Pub. Date: Jan. 16, 2020

(54) SYSTEMS AND METHODS FOR OPTIMAL CONFIGURATION OF INFORMATION HANDLING RESOURCES

(71) Applicant: Dell Products L.P., Round Rock, TX (US)

(72) Inventors: Jose M. GRANDE, Round Rock, TX (US); Wei G. LIU, Austin, TX (US)

(73) Assignee: Dell Products L.P., Round Rock, TX (US)

(21) Appl. No.: 16/034,047

(22) Filed: Jul. 12, 2018

(51) Int. Cl. G06F 9/445; G06F 13/40

(52) U.S. Cl. CPC G06F 9/44505; G06F 13/4081

(57) ABSTRACT

In accordance with embodiments of the present disclosure, an information handling system may include a plurality of processing units and a plurality of slots, each slot configured to receive a corresponding information handling resource, and a program of instructions embodied in non-transitory computer-readable media and configured to, when read and executed by one of the respective processing units: enumerate the plurality of processing units and the information handling resources populated in the plurality of slots; create a processing unit to information handling resources mapping; and based on the mapping, determine whether a population of information handling resources in the plurality of slots is optimal.

### TECHNICAL FIELD

The present disclosure relates in general to information handling systems, and more particularly to methods and systems for optimal configuration of information handling resources in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are evolving to host an increasing number of Non-Volatile Memory Express (NVMe) storage drives. Apart from the performance benefits of using NVMe drives, NVMe drives allow the flexibility for hot-pluggable adding and removing of such drives. However, in multi-socket servers, with the distribution of memory and input/output (I/O) controllers across multiple processors, an end user may configure an information handling system in a manner that may not provide optimal performance because memory and I/O may not be evenly distributed per processor.

### SUMMARY

In accordance with the teachings of the present disclosure, the disadvantages and problems associated with existing approaches to configuration of information handling resources in an information handling system may be reduced or eliminated.

In accordance with embodiments of the present disclosure, an information handling system may include a plurality of processing units and a plurality of slots, each slot configured to receive a corresponding information handling resource, and a program of instructions embodied in non-transitory computer-readable media and configured to, when read and executed by one of the respective processing units: enumerate the plurality of processing units and the information handling resources populated in the plurality of slots; create a processing unit to information handling resources mapping; and based on the mapping, determine whether a population of information handling resources in the plurality of slots is optimal.

In accordance with these and other embodiments of the present disclosure, a method may include, in an information handling system comprising a plurality of processing units and a plurality of slots, each slot configured to receive a corresponding information handling resource, enumerating the plurality of processing units and the information handling resources populated in the plurality of slots, creating a processing unit to information handling resources mapping, and, based on the mapping, determining whether a population of information handling resources in the plurality of slots is optimal.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in an information handling system comprising a plurality of processing units and a plurality of slots, each slot configured to receive a corresponding information handling resource: enumerate the plurality of processing units and the information handling resources populated in the plurality of slots; create a processing unit to information handling resources mapping; and based on the mapping, determine whether a population of information handling resources in the plurality of slots is optimal.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for optimal configuration of information handling resources, in accordance with embodiments of the present disclosure;

and

FIG. 3 illustrates an example information handling resource population mapping, in accordance with embodiments of the present disclosure.

### DETAILED DESCRIPTION

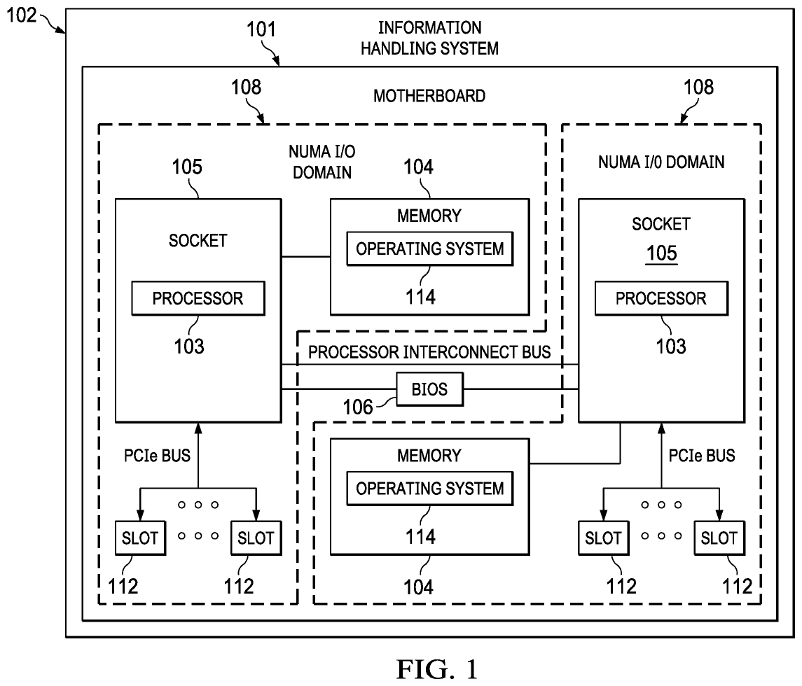

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an information handling system 102. In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a motherboard 101. Motherboard 101 may include a circuit board configured to provide structural support for one or more information handling resources of information handling system 102 and/or electrically couple one or more of such information handling resources to each other and/or to other electric or electronic components external to information handling system 102. As shown in FIG. 1, motherboard 101 may include a plurality of sockets 105, a BIOS 106, a plurality of memories 104, and a plurality of slots 112.

Each socket 105 may comprise any suitable system, device, or apparatus for electrically and mechanically mating a processor 103 to motherboard 101. A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102. As shown, processors 103 may be coupled to one another via an inter-socket bus (e.g., a PCIe bus).

In some embodiments, a processor 103 populated in a socket 105 may comprise a multi-core or multi-die processor, such that a processor 103 comprises a plurality (e.g., two or four) of processing units.

Each memory 104 may be communicatively coupled to processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. As shown in FIG. 1, a memory 104 may have stored thereon an operating system (OS) 114.

OS 114 may comprise any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 114. Active portions of OS 114 may be transferred to memory 104 for execution by processor 103.

Each slot 112 may include a connector (e.g., a receptacle) to provide structural support for receiving a corresponding information handling resource within such slot in order to electrically couple such information handling resource to other electric or electronic components external to such slot 112. For example, each slot may be configured to receive a storage resource. A storage resource may include a hard disk drive, magnetic tape library, optical disk drive, magneto-optical disk drive, compact disk drive, compact disk array, disk array controller, and/or any other system, apparatus or device operable to store media. In particular embodiments, a storage resource may comprise a PCIe device, such as an NVMe storage resource. In such embodiments, a PCIe controller may not be fixed in an information handling system chipset as are traditional storage controllers of traditional storage devices. Instead, PCIe controllers exist on the PCIe (e.g., NVMe storage devices themselves). As shown in FIG. 1, a PCIe bus may couple a slot 112 to a corresponding processor 103.

In FIG. 1, a processor 103, a memory 104 “directly” coupled to a processor 103, and devices disposed in slots 112 “directly” coupled to such processor 103 may form part of a Non-Uniform Memory Access (NUMA) input/output (I/O) domain 108. In operation, a processor 103 may communicate directly with devices within its NUMA I/O domain 108, or indirectly via another processor 103 to devices in another NUMA I/O domain 108. However, processor and device performance may be less efficient when communicating across NUMA I/O domains 108 as compared with communicating within the same NUMA I/O domain 108.

BIOS 106 may be communicatively coupled to processors 103 and include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 106 may be implemented as a program of instructions that may be read by and executed on processor 103 to carry out the functionality of BIOS 106. In these and other embodiments, BIOS 106 may comprise boot firmware configured to be the first code executed by processors 103 when information handling system 102 is booted and/or powered on. As part of its initialization functionality, code for BIOS 106 may be configured to set components of information handling system 102 into a known state, so that one or more applications (e.g., an operating system or other application programs) stored on compatible media (e.g., disk drives) may be executed by processor 103 and given control of information handling system 102.

In operation, BIOS 106 may enumerate the various processors 103 (including multi-core processing units present on processors 103), memories 104, input/output devices, and NUMA I/O domains 108 of information handling system 102. Then, based on various characteristics of information handling system 102, such as, without limitation, memory interleave settings, memory mappings, and PCIe root ports bifurcation, BIOS 106 may create a processing unit to I/O controller population mapping, as well as a processing unit to memory controller population mapping.

BIOS 106 may analyze the mapping information, and may detect whether a current population of PCIe devices in slots 112 is optimal or not. If not, BIOS 106 may take a number of actions. For example, BIOS 106 may display a warning or informational message during power-on self-test (POST) of information handling system 102 to inform the user of information handling system 102 of such sub-optimal configuration. In some embodiments, such message may include a recommendation for a new slot location for a particular device.

In these and other embodiments, BIOS 106 may also suggest adding or removing or relocating certain memory devices (e.g., dual in-line memory modules (DIMMs)) in order to optimize performance. For instance, in a BIOS setup application, a page may be provided to specify the next best slot 112 to install a PCIe device, or the best memory slot to install new memory modules (e.g., including a size/type recommendation as well).

In these and other embodiments, BIOS 106 may also be configured to communicate such information to a remote user (e.g., via a network interface card or via a remote access controller for information handling system 102, such as an Integrated Dell Remote Access Controller), to allow a remote administrator or other user to be provided with information regarding optimal slot population.

Such an approach may also be used during factory production of an information handling system 102, as BIOS 106 may be able to advise a factory technician of a sub-optimal configuration before an information handling system 102 is delivered to a user.

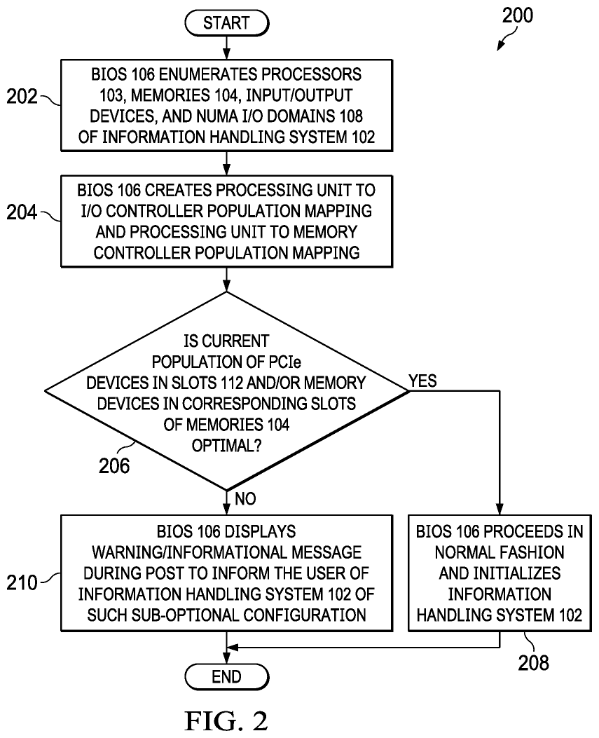

FIG. 2 illustrates a flow chart of an example method 200 for optimal configuration of information handling resources, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

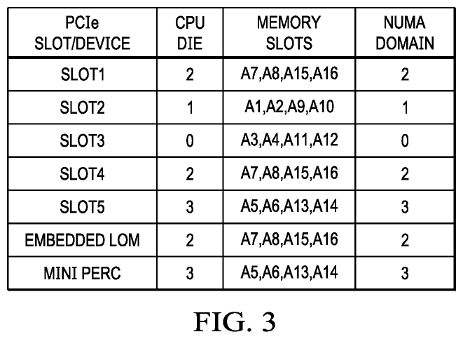

At step 202, BIOS 106 may enumerate the various processors 103 (including multi-core processing units present on processors 103), memories 104, input/output devices, and NUMA I/O domains 108 of information handling system 102. At step 204, based on various characteristics of information handling system 102, such as, without limitation, memory interleave settings, memory mappings, and PCIe root ports bifurcation, BIOS 106 may create a processing unit to I/O controller population mapping, as well as a processing unit to memory controller population mapping. An example of a population mapping is shown in FIG. 3.

At step 206, BIOS 106 may analyze the population mapping and detect whether the current population of PCIe devices in slots 112 and/or memory devices in corresponding slots of memories 104 is optimal or not. If the current population of PCIe devices in slots 112 and/or memory devices in corresponding slots of memories 104 is optimal, method 200 may proceed to step 208. Otherwise, method 200 may proceed to step 210.

At step 208, responsive to the current population of PCIe devices in slots 112 and/or memory devices in corresponding slots of memories 104 being optimal, BIOS 106 may proceed in its normal fashion and initialize information handling system 102. After step 208, method 200 may end.

At step 210, responsive to the current population of PCIe devices in slots 112 and/or memory devices in corresponding slots of memories 104 being sub-optimal, BIOS 106 may display a warning or informational message during power-on self-test (POST) of information handling system 102 to inform the user of information handling system 102 of such sub-optimal configuration. In some embodiments, such message may include a recommendation for a new slot location for a particular device. In these and other embodiments, BIOS 106 may also suggest adding or removing or relocating certain memory devices (e.g., dual in-line memory modules (DIMMs)) in order to optimize performance. In some embodiments, the information may be displayed locally to a user present at information handling system 102. In other embodiments, the information may be displayed remotely to a user of a remote information handling system 102 (e.g., information communicated via a management network). After completion of step 210, method 200 may end. In these and other embodiments, BIOS 106 may cause a management controller (e.g., Integrated Dell Remote Access Controller or iDRAC) to present a user interface page depicting an optimal slot to add a new device and/or proposing a slot reconfiguration map for the non-optimal configuration.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a plurality of processing units;
a plurality of slots, each slot configured to receive a corresponding information handling resource; and
a program of instructions embodied in non-transitory computer-readable media and configured to, when read and executed by one of the respective processing units:
enumerate the plurality of processing units and the information handling resources populated in the plurality of slots;
create a processing-unit-to-information-handling-resources mapping;
based on the mapping, determine whether a population of information handling resources in the plurality of slots is optimal, wherein an optimal population is one that is arranged in a way that is operable to provide better performance than any other potential arrangement of the population; and
in response to a determination that the population of information handling resources is not optimal, communicate information to a user of the information handling system indicating that at least one memory module should be moved from an initial slot to a different slot.

2. The information handling system of claim 1, wherein the memory module is a dual in-line memory module (DIMM).

3. The information handling system of claim 1, wherein the program of instructions comprises a basic input/output system of the information handling system.

4. The information handling system of claim 1, wherein the plurality of slots comprises slots for input/output devices.

5. The information handling system of claim 1, wherein the plurality of slots comprises slots for memory devices.

6. A method comprising, in an information handling system comprising a plurality of processing units and a plurality of slots, each slot configured to receive a corresponding information handling resource:
enumerating the plurality of processing units and the information handling resources populated in the plurality of slots;
creating a processing-unit-to-information-handling-resources mapping;
based on the mapping, determining whether a population of information handling resources in the plurality of slots is optimal, wherein an optimal population is one that is arranged in a way that is operable to provide better performance than any other potential arrangement of the population; and
in response to a determination that the population of information handling resources is not optimal, communicating information to a user of the information handling system indicating that at least one memory module should be moved from an initial slot to a different slot.

7. The method of claim 6, wherein the memory module is a dual in-line memory module (DIMM).

8. The method of claim 6, wherein the method is executed by a basic input/output system of the information handling system.

9. The method of claim 6, wherein the plurality of slots comprises slots for input/output devices.

10. The method of claim 6, wherein the plurality of slots comprises slots for memory devices.

11. An article of manufacture comprising:
a non-transitory computer-readable medium; and
computer-executable instructions carried on the computer-readable medium, the instructions readable by a processor, the instructions, when read and executed, for causing the processor to, in an information handling system comprising a plurality of processing units and a plurality of slots, each slot configured to receive a corresponding information handling resource:
enumerate the plurality of processing units and the information handling resources populated in the plurality of slots;
create a processing-unit-to-information-handling-resources mapping;
based on the mapping, determine whether a population of information handling resources in the plurality of slots is optimal, wherein an optimal population is one that is arranged in a way that is operable to provide better performance than any other potential arrangement of the population; and
in response to a determination that the population of information handling resources is not optimal, communicate information to a user of the information handling system indicating that at least one memory module should be moved from an initial slot to a different slot.

12. The article of claim 11, wherein the memory module is a dual in-line memory module (DIMM).

13. The article of claim 11, wherein the instructions comprise a basic input/output system of the information handling system.

14. The article of claim 11, wherein the plurality of slots comprise slots for input/output devices.

15. The article of claim 11, wherein the plurality of slots comprise slots for memory devices.
